(19) United States
(12) Patent Application Publication
(10) Pub. No.: US 2025/0043441 A1
(43) Pub. Date: Feb. 6, 2025

(54) MEMBRANE ELECTRODE ASSEMBLY AND METHOD FOR PRODUCING SAME

(71) Applicant: Siemens Energy Global GmbH & Co. KG, München (DE)

(72) Inventors: Andre Klinger, Nürnberg (DE); Yashar Musayev, Nürnberg (DE); Günter Schmid, Hemhofen (DE)

(21) Appl. No.: 18/718,890

(22) PCT Filed: Oct. 21, 2022
(86) PCT No.: PCT/EP2022/079389

§ 371 Date: Jun. 12, 2024

(30) Foreign Application Priority Data
Dec. 22, 2021 (DE) 10 2021 214 923.5

(51) Int. Cl. C25B 9/23; C25B 1/04; C25B 11/032; C25B 11/051

(52) U.S. Cl. CPC C25B 9/23; C25B 1/04; C25B 11/032; C25B 11/051

(57) ABSTRACT

The invention relates to a method for producing a membrane electrode arrangement for an electrolysis cell for the electrochemical separation of water into hydrogen and oxygen, including the steps of: providing a substrate having a first surface and a second surface, which faces away from the first surface, coating at least one of the surfaces of the substrate with a catalyst material, immersing the coated substrate in an extraction agent to at least partially extract a solvent from the catalyst material, and drying the coated substrate at a temperature that is lower than 60° C.

### BACKGROUND

The invention relates to a method for producing a membrane electrode assembly for an electrolysis cell for the electrochemical separation of water into hydrogen and oxygen. Furthermore, the invention relates to a membrane electrode assembly having at least one membrane that has a respective catalyst material on two surfaces facing away from one another.

Hydrogen is an important substance that is used in countless applications in industry and technology. Generally, hydrogen occurs on Earth only in a bound state. One of those substances that contains hydrogen in the bound state is water. Furthermore, hydrogen can also be used as an energy store, in particular in order to store electrical energy generated by regenerative energy generation methods for subsequent applications.

An important process for obtaining hydrogen is the electrolysis of water, in particular using electrical energy. Hydrogen can in this case be used, inter alia, as an energy store, in that for example it is used as a fuel in order to stabilize the electrical energy supply in particular from renewable energies, such as wind power, photovoltaics or the like. It is however also possible to use hydrogen for other processes in which a fuel or a reducing agent is needed. The hydrogen obtained in electrolysis can therefore for example be used industrially or electrical energy can be recovered electrochemically using fuel cells.

The separation of water into its chemical constituents hydrogen and oxygen can be carried out by suitable electrolysis cells. For this purpose, these can be in the form of what are known as polymer electrolyte membrane electrolysis cells. Usually provided in the case of such an electrolysis cell is a membrane that has a respective catalyst layer on surfaces facing away from one another. The catalyst layers are usually adjoined by respective gas diffusion layers, which in turn are adjoined by respective electrically conductive contact plates, occasionally also referred to as bipolar plates, which are used inter alia for electrical contacting. At the same time, the contact plates or the bipolar plates are preferably also configured such that they can enable the required mass transfer in operation as intended during the electrolysis in the electrolysis cell. For this purpose, appropriate channels can be provided for supplying a respectively suitable electrolyte and for discharging the reaction products of the electrolysis, namely a hydrogen gas and an oxygen gas. The gas diffusion layer usually provides electrical conductivity in order to electrically couple the contact plates and the catalyst layers to one another. This makes it possible to realize the desired electrochemical reaction in the region of the catalyst layers.

If the electrolysis reaction is a reaction in the alkaline range, an anion exchange membrane (AEM) is provided as the membrane. In contrast, if the electrolysis reaction takes place in the acidic range, a proton exchange membrane (PEM) is provided instead.

Hydrogen is produced from water via the electrolysis process. This is an electrochemical procedure in which water is separated into its chemical constituents oxygen and hydrogen. Depending on the mode of operation, the electrochemical cell reactions can be described and differentiated as follows:

### Alkaline Electrolysis:

| | | |
|---|---|---|
| Anode electrode | 4OH⁻ → 2H₂O + O₂ + 4e⁻ | (1) |
| Cathode electrode | 2H₂O + 2e⁻ → 2OH⁻ + H₂ | (2) |

### Acidic Electrolysis:

| | | |
|---|---|---|
| Anode electrode | 2H₂O → 4H⁺ + O₂ + 4e⁻ | (1) |
| Cathode electrode | 4H⁺ + 4e⁻ → H₂ | (2) |

In a polymer electrolyte membrane electrolysis, the respective two partial reactions are spatially separated by an ion-conductive membrane. In an electrolysis in the alkaline range an anion exchange membrane (AEM) is provided here, whereas in an electrolysis in an acidic medium a proton exchange membrane (PEM) is provided. The construction of the membrane electrode assembly (MEA) can however in both cases be fundamentally comparable.

A membrane electrode assembly (MEA) usually forms a core of such a polymer electrolyte membrane electrolysis cell. The membrane electrode assembly includes at least the membrane, which is usually coated both on the anode side and on the cathode side on two surfaces facing away from one another with a layer of a respective catalyst material. The respective cell reaction of the electrolysis proceeds in the region of the layer formed by the respective catalyst material. During operation as intended, electrons are conducted away to the contact plates via the respective catalyst material and a support structure that can be formed by the gas diffusion layer or can provide the latter. For this reason, high electrical conductivity of the catalyst layers is desired.

In addition to electrons, hydroxide anions OH⁻ are formed in the reaction in the alkaline range and protons H⁺ are formed in operation in the acidic range, these being moved through the respective membrane as charge carriers. In this regard, good conductivity of the structure of the layers of the respective catalyst materials is therefore desired in order to convey the respective ions to the membrane or from the membrane to the respective catalyst materials. It thus represents a technical challenge to simultaneously provide good ionic bonding of the catalyst material to the membrane and good electrical conductivity of the catalyst material.

In the prior art, membrane electrode assemblies or units are produced by providing the catalyst materials in the form of a paste that is applied either directly to the appropriate surface of the membrane or to the appropriate surface of a substrate. The paste-like or pasty catalyst material here consists of the catalyst material itself, an ionomer, a polymeric binder and a solvent. After the application, the solvent is usually thermally removed or thermally driven out, for which purpose the layers of catalyst material are pressed with the membrane at a high temperature usually greater than 100° C. This is intended to ensure the ionic contact of the ionomer and the catalyst material with the membrane.

The abovementioned procedure requires the material of the membrane, particularly for the pressing, to have a low softening temperature in order to enable particles of capacitor material to penetrate into edge regions of the membrane. At the same time, however, sintering of catalyst particles of the capacitor material should be minimized. The desired low softening temperature equally limits the maximum operating temperature of the electrolysis cell. This in turn limits the efficiency and at the same time requires a correspondingly high level of outlay in the production of the membrane electrode assembly or of the electrolysis cell having such a membrane electrode assembly.

### SUMMARY

The invention is based on the object of specifying a membrane electrode assembly and a method for the production thereof, by way of which at least an outlay for the production can be reduced or a reliability of the electrolysis cell can be increased.

In one embodiment, a method for producing a membrane electrode assembly for an electrolysis cell for the electrochemical separation of water into hydrogen and oxygen is provided. The method includes providing substrate having a first surface and a second surface facing away from the first surface, coating of at least one of the surfaces of the substrate with a catalyst material, immersion of the coated substrate into an extractant to at least partially extract a solvent from the catalyst material and to take up the solvent by the extractant, the solvent being extracted from the catalyst material by way of diffusion of the solvent from the catalyst material into the extractant, and drying of the coated substrate at a temperature less than 60° C., preferably less than 50° C., particularly preferably less than 48° C.

With respect to a generic membrane electrode assembly, it is proposed in particular that the membrane electrode assembly is produced according to the production method according to the invention and a polymer proportion of the catalyst material in relation to a dry mass of the catalyst material is 2.5% to 25%.

The invention achieves the abovementioned object by providing a paste made of catalyst material, with the production process being combined with a low-temperature process in which the temperature remains essentially less than about 60° C. The invention in particular makes it possible to largely avoid nonionic binders or polymers. All that it requires is an ionic binder or an ionomer to be dissolved in a solvent, preferably with a high viscosity, and then to be mixed with the catalyst material. The viscosity of the paste made of catalyst material that is produced in this way can thus be adjusted via the ionomer proportion in the solvent in such a way that use can be made of conventional industrial processing methods for an electrode paste, such as knife coating or else dip coating. By extracting the solvent, as will be explained further below, a pore structure can be created at the same time, which makes it possible to improve the chemical reactions, with the result that an improvement in the efficiency of the electrolysis can also be achieved.

Directly applying the paste made of catalyst material to the substrate or the membrane and subsequently extracting the solvent makes it possible to produce a membrane electrode assembly with low thermal stress on the membrane. As a result, the production method can be simplified. Furthermore, it is also possible to use new material classes for the membrane which have the lowest possible softening behavior. As a result, it is possible to achieve for example a higher operating temperature for the membrane electrode assembly. The use of an ionic binder or polymer can further achieve better immobilization of the layer of the catalyst material, meaning that a service life of the electrodes formed thereby can be extended.

On the anode side, the catalyst material may for example includes one or more of the following substances, specifically nickel-aluminum, nickel-zinc, cobalt-aluminum, cobalt-iron, nickel-iron, nickel-iron-vanadium, nickel-cobalt, nickel-molybdenum, nickel-iron double layered hydroxide, nickel-iron-cobalt, iridium, ruthenium oxide, nickel hydroxide, nickel oxide, nickel.

On the cathode side, the catalyst material may for example includes one or more of the following substances, specifically nickel, nickel-molybdenum on carbon black, nickel-molybdenum, nickel-platinum, platinum, nickel on carbon black, nickel phosphate, nickel-vanadium.

The substrate may be in the form of a film, a strip or the like. The substrate has two surfaces that are facing away from one another and are preferably oriented essentially parallel to one another. The substrate may for example be in the form of a flat, preferably rigid element. This makes it possible to subject the substrate also to a continuous manufacturing process, with the result that a membrane electrode assembly of any desired length can be produced, which, as required, can be specifically adapted to dimensions of the electrolysis cells and cut to length appropriately for the use conditions.

Once the catalyst material has been applied to the at least one surface of the substrate, the coated substrate is immersed into the extractant, by way of which the solvent is at least partially extracted from the catalyst material. The extraction is based here in particular on a diffusion procedure, meaning that a treatment at a temperature of greater than about 100° C. can largely be avoided. The extractant is selected to match the solvent so that the desired diffusion process can take place. For this purpose, provision may be made for the extractant to be arranged in an extraction bath. The coated substrate can then be guided through the extractant present in the extraction bath by being immersed. This may also be provided in the manner of a continuous procedure, by for example guiding a coated substrate of any desired length through the extraction bath via a roller guide. A length of the coated substrate guided in the extraction bath may for example be in a range of about 1 m to about 5 m. A conveying speed of the coated substrate in the extraction bath may for example be in a range of about 10 mm/s to about 100 mm/s. This enables the removal of a predominant proportion of the solvent from the coating of the substrate, with the result that the desired properties can be achieved. This means that only the components that are not soluble in the extraction bath remain in the catalyst layer and thus on the substrate or the membrane.

Following the step of immersion is a step of drying of the coated substrate at a temperature less than 60° C., preferably less than 50° C., particularly preferably less than 48° C. This drying procedure essentially serves merely to remove residues of the extractant that are still adhering to the coated substrate after the step of immersion. This also explains, moreover, why a comparatively low temperature is sufficient for the drying in the case of the invention. It is thus in particular no longer necessary to heat the coated substrate to a temperature of greater than 100° C. As a result, the disadvantages and problems that occur in the prior art can largely be avoided or reduced.

The step of drying may be carried out in a suitable drying oven, which in the case of continuous manufacture may also be a continuous oven, through which the coated substrate is guided after the step of immersion. Subsequently, the desired membrane electrode assembly is then available. This can then be accordingly processed further in the context of the production of electrolysis cells, for example by fluidically and/or electrically bringing the layer with catalyst material into contact with a contact plate. The bringing into contact may of course also include the arrangement of a preferably at least partially electrically conductive gas diffusion layer between the layer of catalyst material and the contact plate.

The membrane electrode assembly usually has at least a cathode region and an anode region formed to be separated from the cathode region by the membrane, which acts as separator. To carry out the electrochemical reaction in the electrochemical cell, an anode electrode is arranged in the anode region and a cathode electrode is arranged in the cathode region, to which, as electrodes provided by respective catalyst material, a suitable electrical potential is applied in operation as intended. The catalyst material supports or enables the desired reaction both in the anode region and in the cathode region.

The reaction in the electrochemical cell of the membrane electrode assembly preferably uses an electrolyte. The electrolyte may for example be formed by an aqueous solution of a suitable substance, for example potassium hydroxide, sodium hydroxide or the like. The electrolyte may be the same on the anode side and on the cathode side. The electrolyte may therefore be provided from a single reservoir. Such an electrolyte is occasionally also called a monolyte. Furthermore, there is of course also the possibility of using different electrolytes in the anode region and in the cathode region, the cathode region then having what is called a catholyte and the anode region having what is called an anolyte.

The membrane electrode assembly is usually arranged between two contact plates, with one contact plate having channels for discharging hydrogen and the other contact plate having channels for discharging oxygen. The channels usually face the membrane electrode assembly and may be configured so as to be at least partially open. The channels form a channel structure, which is also referred to as a flow field. The electrodes, specifically the anode electrode and the cathode electrode, may for example be in the form of gas diffusion electrodes (GDEs). These enable the function of, on the one hand, making electrical contact and, on the other hand, allowing substances of the reaction, reactants and products, to diffuse, so that a desired transport of the reactants and the products of the electrochemical reaction is achieved. A gas diffusion electrode here has at least one gas diffusion layer, and usually contacts the respective layer of catalyst material at which the electrochemical reaction takes place.

Ionomers are polymeric materials having ionic chemical groups. Suitable proton-conductive ionomers are for example homogeneous perfluorinated polymers such as Nafion (Dupon), Dow membranes (Dow), Flemion (Asahi Glas) and Aciplex (Asahi Kasehi). These polymers have a perfluoroalkyl main chain with perfluoroalkyl ether side chains, at the end of which is arranged a sulfonic acid group or in some cases also a carboxylic acid group. Perfluorinated ionomer membranes are characterized by particularly high chemical and thermal stability, high water permeability and cation selectivity. Suitable anion-conducting membranes are for example Aemion+ (Ionomer), Sustanion (Dioxide Materials), Piperion (Versogen), Durion (Xergy), which are based on a wide variety of material masters. For example, these can include polybenzimidazolium-, polyphenylene- or polystyrene-based polymers.

Also useful are partially fluorinated ionomers. These include for example grafted ionomers obtainable for example by γ-irradiation of partially fluorinated polymers, subsequent grafting with for example styrene and/or divinylbenzene and subsequent sulfonation. These also include sulfonated poly(α,β,β′-trifluorostyrene) homo- and copolymers.

Preferably, at least one membrane of the membrane electrode assembly is provided by the substrate. As a result, the membrane can be in direct contact with the catalyst material, and so a good connection between the membrane and the catalyst material can be achieved. In particular, it is for example also possible to achieve an assembly that can be handled individually and is particularly suitable for further processing in the production of the membrane electrode assembly or the electrolysis cell.

It is further proposed that, before the step of immersion, an electrically conductive nonwoven material is applied to the membrane coated with the catalyst material. The nonwoven material preferably has electrical conductivity so that good electrical contacting of the electrodes or of the catalyst materials can be achieved. In particular, the nonwoven material may at least partially also contain catalyst material. Preferably, catalyst material, in particular the paste containing the catalyst material, can penetrate at least partially into the nonwoven material during the production method. The electrochemical functionality can be further improved as a result. The nonwoven material applied to the coated membrane may preferably be exposed to the extractant and then dried together with the coated membrane. This makes it possible to achieve a good connection between catalyst material and nonwoven material and a high functionality of the membrane electrode assembly. The nonwoven material may for example include felt, gauze, fabric or the like. Furthermore, provision may be made for the nonwoven material to be at least partially provided with an electrically conductive metallization in order to achieve or improve the electrical conductivity of the nonwoven material. The nonwoven material may also be formed from an electrically conductive substance. By way of example, the nonwoven material may include stainless steel, nickel, black steel, high-alloy steels, carbon and/or the like.

It is further proposed that the substrate includes an electrically conductive nonwoven material which, after the drying, is brought into contact with a membrane of the membrane electrode assembly. In this configuration, provision may thus be made for a composite to first be produced from a layer of catalyst material and the nonwoven material. This composite may then subsequently be brought into contact with the membrane of the membrane electrode assembly. The abovementioned production options may of course also be combined with one another. Due to the fact that the nonwoven material and the substrate are applied to the preferably still moist, coated membrane, an electrical transverse conductivity between catalyst particles of the catalyst material can be improved, as a result of which electrical losses of the electrode can be reduced in operation as intended. This configuration thus does not require the membrane to be coated first. Rather, it is sufficient if the nonwoven material, which at the same time can advantageously serve as a support structure here, is first coated with the catalyst material or the paste made of catalyst material and then the membrane and the coated nonwoven material are brought into direct contact, before the extraction step and the drying step are subsequently carried out.

According to a development, it is proposed that a catalyst material having a viscosity in a range of about 50 mPa·s to about 500 mPa·s at a temperature of about 25° C. is used to coat the substrate. Such a viscosity has proven to be particularly suitable in order to be able to perform the step of coating as favorably as possible. In particular, this can enable or improve a knife-coating process, an application by nozzles, a dip-coating process or the like.

It is further proposed that the solvent used is at least one substance from a group including at least N-methylpyrrolidine, a heterocyclic cycloalkanone, dimethyl sulfoxide, diacetone alcohol, ethyl acetate, butyl glycol and an alcohol having fewer than four carbon atoms. Such solvents have proven to be particularly advantageous for the performance of the method. The invention is however not restricted to the use of these solvents.

It is further proposed that the extractant used is at least water, a ketone or an alcohol. These extractants have proven to be suitable for removing or leaching out the abovementioned solvents from the membrane electrode assembly. The invention is however not restricted to the use of these extractants.

According to a development, it is proposed that the step of drying is performed at least partially at reduced pressure. The drying procedure can be significantly accelerated as a result. The step of drying may be carried out in an appropriately configured oven. For the purpose of the drying, provision may for instance be made for a flow of hot air, infrared radiation or the like to be applied at least partially to the coated substrate. Provision may of course also be made for the pressure to not be constant during the step of drying, that is to say to therefore vary, in order to optimize the drying procedure. For example, provision may be made for drying at ambient pressure to be performed in sections and drying at negative pressure to be performed in sections.

According to a further configuration, it is proposed that the catalyst material used is a catalyst material free of a nonionic binder. This enables an increase in the service life of the electrodes.

With respect to the membrane electrode assembly, it is further proposed that the membrane electrode assembly has a support structure, the support structure having pores with a diameter of about 2 μm to about 200 μm, preferably of about 4 μm to about 110 μm. This pore structure makes it possible to achieve a further improvement in the electrolysis process in operation as intended. The support structure may for example be at least partially formed by the nonwoven material.

With respect to the membrane electrode assembly, it is further proposed that the catalyst layer has pores with a diameter in a range of about 0.01 μm to about 1 μm, preferably of about 0.04 μm to about 0.09 μm. This pore structure makes it possible to achieve a further improvement in the electrolysis process in operation as intended.

The advantages and effects stated for the production method according to the invention of course equally also apply to the membrane electrode assembly of the invention, and vice versa. In this respect, method features may accordingly also be formulated as device features, and vice versa.

The features and combinations of features stated above in the description and the features and combinations of features stated below in the description of the figures and/or shown in the figures alone are usable not only in the respectively specified combinations but also in other combinations, without departing from the scope of the invention.

The exemplary embodiments elucidated below are preferred embodiments of the invention. The features and combinations of features specified above in the description and also the features and combinations of features stated in the following description of exemplary embodiments and/or shown in the figures alone are usable not only in the respectively specified combination but also in other combinations. Thus, embodiments that are not explicitly shown in the figures and elucidated but emerge and are producible from the elucidated embodiments by separate combinations of features can also be considered to be encompassed or disclosed by the invention. The features, functions and/or effects presented by the exemplary embodiments can represent, each taken alone, individual features, functions and/or effects of the invention that are to be considered independently of one another and which each also independently of one another develop the invention. Therefore, the exemplary embodiments are intended to also encompass combinations other than those in the elucidated embodiments. Furthermore, the embodiments described can also be supplemented by further already-described features, functions and/or effects of the invention.

### BRIEF DESCRIPTION OF THE FIGURES

In the figures, identical reference signs denote identical features and functions.

### In the Figures:

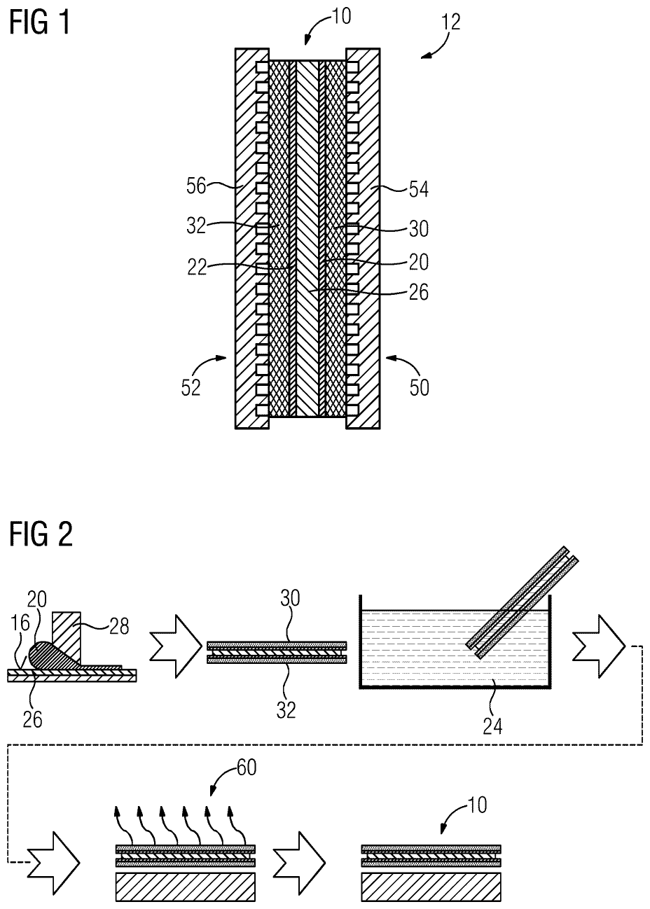

FIG. 1 shows a schematic sectional view through an electrolysis cell with a membrane electrode assembly for the electrolysis of water;

FIG. 2 schematically shows a first production method for producing the membrane electrode assembly according to FIG. 1;

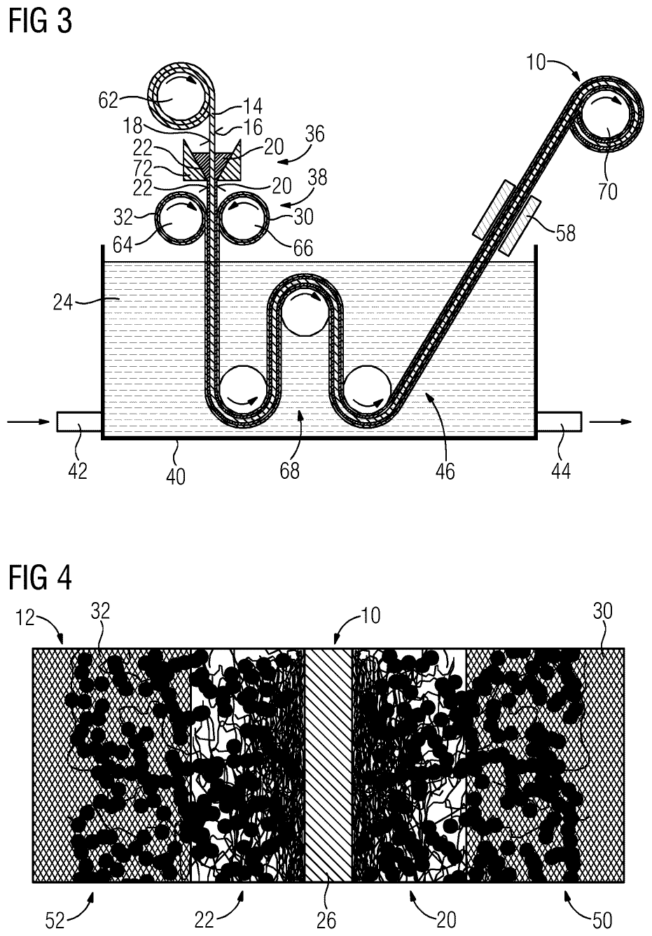

FIG. 3 shows a schematic view of a second production method for producing the membrane electrode assembly according to FIG. 1;

FIG. 4 shows a schematically enlarged illustration of a sectional view of a detail of the membrane electrode assembly according to FIG. 2 or 3;

FIG. 5 shows a perspective plan view of an electrode of the membrane electrode assembly according to FIG. 4 on a carbon nonwoven as nonwoven material;

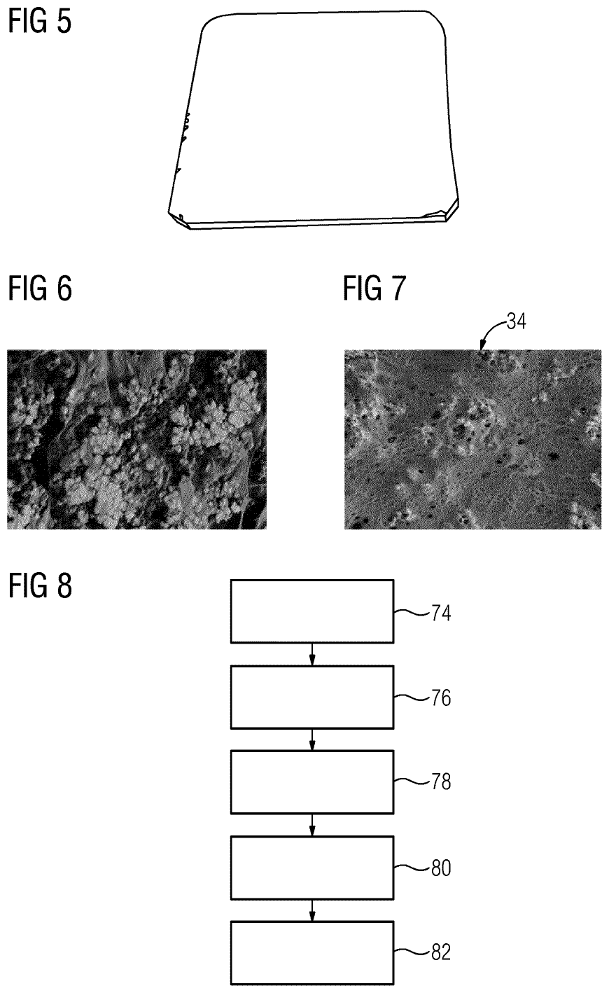

FIG. 6 shows a schematic enlarged sectional illustration of a detail of the electrode according to FIG. 5;

FIG. 7 shows a schematic enlarged illustration of a region of the plan view according to FIG. 5; and

FIG. 8 shows a schematic illustration of a sequence for the method according to FIG. 2.

### DETAILED DESCRIPTION

FIG. 1 shows a schematic sectional view of an electrolysis cell 12 with a membrane electrode assembly 10. As illustrated, the membrane electrode assembly 10 has a membrane 26 having two surfaces 16, 18 which face away from one another and on which a respective catalyst material 20, 22 is arranged. The catalyst material 20, 22 in turn contacts a respective gas diffusion layer that is formed by a respective nonwoven material 30, 32 and that in turn contacts a respective contact plate 54, 56 on the opposite side. This forms an anode region 50 and a cathode region 52. The contact plates 54, 56 and also the gas diffusion layers are configured so as to be electrically conductive, and so electrical contact is made between the respective one of the catalyst materials 20, 22 and the respective contact plate 54, 56. The contact plates 54, 56 further have flow channels, not denoted, via which on the one hand water or electrolyte can be supplied to the electrolysis cell 12 and on the other hand electrolysis products, namely hydrogen and oxygen, can be discharged.

In addition to a membrane 26, the membrane electrode assembly 10 includes the layers of catalyst material 20, 22. The membrane electrode assembly 10 may be produced as a component that can be handled individually, so that the membrane electrode assembly 10 can be handled in a simple manner in the manufacturing process of the electrolysis cell 12.

The membrane electrode assembly 10 includes at least the anode-side and the cathode-side catalyst layer, which are usually connected to the membrane 26 to form one component. The respective chemical reactions take place in the catalyst layers, with electrons being able to be conducted away to the contact plates 54, 56 via the catalyst and any support structure that is electrically conductive. It is therefore advantageous if the respective layer of catalyst material 20, 22 has the best possible electrical conductivity. Furthermore, hydroxide ions OH⁻ are produced in the alkaline medium and protons H⁺ are produced in the acidic medium, which migrate through the respective membrane as charge carriers. It is therefore also desirable for the catalyst materials 20, 22 to have a correspondingly good conductivity for the respective ions so that they can readily be conveyed to the membrane 26 or from the membrane 26 to the respective catalytic centers. It is therefore desirable for good ionic bonding of the respective catalyst material 20, 22 to the respective surface 16, 18 of the membrane 26 and at the same time good electrical conductivity of the catalyst material 20, 22 to be able to be provided.

As can be seen from FIG. 2, to produce the membrane electrode assembly 10 according to FIG. 1, the membrane 26 is first provided as substrate 14 according to a step 74 in a schematic flowchart according to FIG. 8. The membrane 26 includes the surface 16 and the second surface 18 facing away from the first surface 16. In an illustration on the far left (FIG. 2), a coating tool 28 is provided for the purpose of coating with the respective catalyst materials 20, 22. The catalyst materials 20, 22 are provided in the present case in paste form, in particular as a pasty compound, so that they can readily be applied to the respective one of the surfaces 16, 18 by the coating tool 28.

In the present case, provision is made for catalyst particles of the respective catalyst material 20, 22 to be dissolved and mixed only with an ionomer in a highly viscous solvent. The production of the catalyst paste is not shown in the figures. However, conventional methods for mixing substances can be used for this purpose. In contrast to the prior art, this method however does not require the addition of a polymeric binder or nonionic binder. The viscosity of the paste can be adjusted via the ionomer proportion in the solvent in such a way that use can be made of conventional industrial coating methods for electrode pastes. For example, knife coating or dip coating can alternatively also be provided.

The solvent used is preferably a substance from a group including at least N-methylpyrrolidine, a heterocyclic cycloalkanone, dimethyl sulfoxide, diacetone alcohol, ethyl acetate, butyl glycol and an alcohol having fewer than four carbon atoms. By suitably adjusting the proportions, it can be achieved that the paste produced in this way as catalyst material 20, 22 has a desired viscosity in a range of about 50 mPa·s to about 100 mPa·s at a temperature of 25° C.

Coating is performed in a step 76. The two surfaces 16, 18 of the membrane 26 can be coated with the respective catalyst material 20, 22 by direct application to the respective one of the surfaces 16, 18. The manufacturing direction is indicated by arrows in FIG. 2.

Once the respective catalyst materials 20, 22 have been applied to the respective surfaces 16, 18, provision is made in a next step 78 for a respective electrically conductive nonwoven material 30, 32 to be applied to the membrane 26 coated with the catalyst material 20, 22. This is shown in the second illustration from the left of the manufacturing steps in FIG. 2.

In this step 78, a respective carbon nonwoven is also applied as nonwoven material 30, 32 to the coated membrane 26. However, the application of the nonwoven material 30, 32 is an optional step and can also be performed at another point in the procedure or be dispensed with.

In the next step 80 (middle illustration in FIG. 2), the composite with the coated substrate 14, which in the present case is formed by the coated membrane 26, on both sides of which nonwoven material 30, 32 is arranged, is immersed into an extractant 24, which in the present case is formed by water. In alternative configurations, the extractant 24 may also be formed by an alcohol or the like, or a mixture of different substances forming the extractant. The extractant 24 is selected so as to match the solvent.

During the immersion, the solvent is at least partially extracted from the catalyst material 20, 22 and taken up by the extractant 24. In the present case, the solvent is extracted from the catalyst material 20, 22 predominantly by diffusion from the catalyst material 20, 22 into the extractant 24. As a result, it is possible to avoid the drying methods customary in the prior art that are usually performed at temperatures of significantly above 100° C. This not only saves energy, but ultimately also makes it possible to obtain an improved structure of the membrane electrode assembly 10, which enables an improvement in the manufacture and an increase in the efficiency.

Lastly, there follows in a next step 60, 82 the drying of the coated substrate 14, here of the coated membrane 26, at a temperature less than 60° C., preferably less than 50° C., particularly preferably less than 48° C. The drying procedure can be performed in an oven 58. It preferably serves to remove residues of the extractant 24. If water is used as extractant, the drying can for example be effected thermally by action of heat, thermal radiation or else by use of microwaves. If required, combinations of these can also be provided. Finally, the membrane electrode assembly 10 is obtained as a result of this production method (right illustration in FIG. 2) and so it can be arranged in the electrolysis cell 12 according to FIG. 1.

The nonwoven material 30, 32 may for example also be in the form of a felt, fabric or the like. Preferably, it is essentially hardly plastically deformable, but is rollable. As a result, the production method is also suitable for essentially continuous production.

In order to be able to realize the electrical contacting when using the nonwoven material 30, 32, the nonwoven material 30, 32 may for example be metallized or else be formed from a metal or another electrically conductive substance, such as carbon or the like.

The substrate 14 is immersed into the extractant 24 preferably over a length of about 1 m to 5 m at a conveying speed of about 20 mm/s to about 100 mm/s.

It has been shown to be suitable when producing the catalyst material in paste form for a proportion of the ionic polymer to be about 5% to about 25% in relation to a dry mass of the catalyst material 20, 22.

FIG. 3 now shows a schematic illustration of a production process for the membrane electrode assembly 10 that is based on the production method according to FIG. 2. For this purpose, a catalyst coating device 36 is provided in terms of plant technology in FIG. 3. As can be seen in FIG. 3, the membrane 26 and also the nonwoven materials 30, 32 here are provided so as to be able to be unrolled from rollers 62, 64, 66 in order to enable continuous production by the catalyst coating device 36 and a nonwoven coating device 38. The nonwoven coating device 38 is used to apply a respective nonwoven including a nonwoven material 30, 32 to the membrane 26.

An extraction bath 40 is also provided, in which the extractant 24 is arranged. The extraction bath 40 has an inlet 42 and an outlet 44 so that during a continuous production process concentrations of the substances in the extractant 24 can be controlled or adjusted in a definable manner.

It can further be seen from FIG. 3 that the substrate 14, in this configuration the membrane 26, is provided wound up on the roller 62. The substrate 14 is unwound from the roller 62 during the production method and guided through a coating device 72 so that the respective surfaces 16, 18 of the substrate 14 or of the membrane 26 can be coated with the respective paste made of catalyst material 20, 22.

Following this, the nonwoven material 30, 32 is unrolled from the rollers 64, 66 and brought into contact with the layers of catalyst material 20, 22. The composite produced in this way is then immersed into the extraction bath 24 and guided via a roller device 68 in the extraction bath 40. The roller device 68 serves in the present case at least partially also as conveying device 46.

Subsequently, the composite is guided through an oven 58 so that drying, in particular with respect to the extractant 24, can be achieved. Finally, the membrane electrode assembly 10 produced in this way is wound up on a roller 70 for the further processing to produce the electrolysis cells 12.

It can be seen from FIG. 3 that a very simple and reliable production procedure for the membrane electrode assembly 10 can be achieved. Nonpolymeric binder can be completely avoided in this case. The solvent dissolves very readily in the extractant 24, whereas the catalyst material 20, 22 and the ionomer present therein barely dissolve, if at all. As a result, the solvent escapes from the layers of catalyst material 20, 22, leaving behind a composite composed of a support structure, which can be formed in particular by the nonwoven material 30, 32, ionomer and catalyst material 20, 22. At the same time, the escape of the solvent in the region of the catalyst material 20, 22 makes it possible to achieve a very advantageous pore structure, which moreover particularly promotes the functioning of the electrode, as illustrated on the basis of FIGS. 5 to 7 elucidated further below.

Furthermore, brief dissolution of the membrane 26 additionally makes it possible to produce or at least improve a bond between the membrane 26 and the elements or substances arranged on the surfaces 16, 18, as shown for example in FIG. 2. The swelling of the membrane 26 due to an effect of the solvent can be realized by fiber-reinforced membranes or by a very prompt extraction of the solvent. Due to a suitable proportion of polymer by way of the ionic binder, the electrode in each case formed thereby has very good elastic properties, with the result that crack formation in the electrode layer or detachment from the membrane 26 during swelling processes can be significantly reduced. This also explains why the functionality of the invention can lead not only to a more favorable production method, but also to higher reliability and higher quality of the membrane electrode assembly produced in this way and therefore also of the resulting electrolysis cell 12.

Due to the precipitation of the ionomer at the boundary to the extractant 24, an ionomer film that is typical for this process can form at the edges of the respective electrode. The film formation can be influenced by the type of the extractant, which is water in the present case. This makes it possible for example to achieve thick films of ionomer. This process can moreover be used to control the distribution of ionomer within the respective electrode and thereby to achieve a more favorable electrode morphology, so that the mass transfer within the electrode can be improved and therefore also the efficiency can be improved.

FIG. 4 shows a schematic sectional view of a detail of a cross section of the membrane electrode assembly 10 produced according to FIG. 3, as can be used to produce an electrolysis cell 12 according to FIG. 1. It is apparent that particles of catalyst material 20, 22 are not limited to the originally applied layer, but have also reached adjacent areas. This makes it possible to further improve the effect of the invention.

FIG. 5 now shows a perspective plan view of an electrode side of the membrane electrode assembly 10 produced using the method according to FIG. 2.

Shown in FIG. 6 is an enlarged illustration of a detail of a cross section of the electrode shown in FIG. 5. A carbon nonwoven is provided as nonwoven material in the present case.

FIG. 7 shows a schematically enlarged illustration of a plan view of any area according to FIG. 5, in which corresponding pores 34 can be seen.

A difference between the production methods of the prior art and the invention is in particular that a simplification of the production method can be achieved in that only an essentially three-step process needs to be provided to produce the membrane electrode assembly 10, which includes the steps of coating 76, immersion 80 (extraction) and drying 82. The drying 82 can be carried out here at a low temperature level.

In contrast to in the prior art, in the invention the solvent of the paste that contains the catalyst material is not thermally driven out, but instead removed only by extraction. Furthermore, with the invention it is possible to form an effective ionomer film, as a result of which better bonding of the catalyst material 20, 22 can in particular be achieved on the membrane side.

As can be seen in particular from the exemplary embodiment according to FIG. 3, the method according to the invention has proven to be particularly suitable for being able to coat both sides of the membrane 26 or the substrate 14 in one process step, even if the invention can also be used for just one-sided coating. Furthermore, the production method according to the invention makes it possible to also change the order of the steps of coating and of production of the composite when using a nonwoven material. Provision may thus in principle also be made for the substrate 14 to be formed by a respective nonwoven material 30, 32, which is first coated with the respective catalyst material 20, 22. This is followed by the contacting of the membrane 26 before the immersion 80. As the end result, the same membrane electrode assembly 10 can be produced in this way.

The exemplary embodiments of the invention serve exclusively to elucidate the invention and are not intended to restrict it.

1. A method for producing a membrane electrode assembly for an electrolysis cell for electrochemical separation of water into hydrogen and oxygen, having the following steps:
provision of a substrate having a first surface and a second surface facing away from the first surface,
coating of at least one of the surfaces of the substrate with a catalyst material,
immersion of the coated substrate into an extractant to at least partially extract a solvent from the catalyst material and to take up the solvent by the extractant, the solvent being extracted from the catalyst material by way of diffusion of the solvent from the catalyst material into the extractant, and
drying of the coated substrate at a temperature less than 60° C.

2. The method as claimed in claim 1, characterized in that at least one membrane of the membrane electrode assembly is provided by the substrate.

3. The method as claimed in claim 2, characterized in that, before the step of immersion, an electrically conductive nonwoven material is applied to the membrane coated with the catalyst material.

4. The method as claimed in claim 1, characterized in that the substrate comprises an electrically conductive nonwoven material which, after the drying, is brought into contact with a membrane of the membrane electrode assembly.

5. The method as claimed in claim 1, characterized in that a catalyst material having a viscosity in a range of 50 mPa·s to 500 mPa·s at a temperature of 25° C. is used to coat the substrate.

6. The method as claimed in claim 1, characterized in that the solvent used is at least one substance from a group comprising at least N-methylpyrrolidine, a heterocyclic cycloalkanone, dimethyl sulfoxide, diacetone alcohol, ethyl acetate, butyl glycol and an alcohol having fewer than four carbon atoms.

7. The method as claimed in claim 1, characterized in that the extractant used is at least water, a ketone or an alcohol.

8. The method as claimed in claim 1, characterized in that the step of drying is performed at least partially at reduced pressure.

9. The method as claimed in claim 1, characterized in that the catalyst material used is a catalyst material free of a nonionic binder.

10. A membrane electrode assembly having at least one membrane that has a respective catalyst material on two surfaces facing away from one another, characterized in that the membrane electrode assembly is produced as claimed in claim 1 and an ionic polymer proportion of the catalyst material in relation to a dry mass of the catalyst material is 5% to 25%.

11. The membrane electrode assembly as claimed in claim 10, characterized by a support structure having pores with a diameter of 2 μm to 200 μm, preferably of 4 μm to 110 μm.

12. The membrane electrode assembly as claimed in claim 10, characterized in that the catalyst material has pores with a diameter of 2 μm to 200 μm.
